(19) United States
(12) Patent Application Publication
(10) Pub. No.: US 2020/0067903 A1
(43) Pub. Date: Feb. 27, 2020

(54) Integration of Publish-Subscribe Messaging with Authentication Tokens

(71) Applicant: INTERNATIONAL BUSINESS MACHINES CORPORATION, ARMONK, NY (US)

(72) Inventor: Anton Yegorin, Dublin (IE)

(21) Appl. No.: 16/111,767

(22) Filed: Aug. 24, 2018

(51) Int. Cl. H04L 29/06; H04L 29/08

(52) U.S. Cl. CPC H04L 63/0807; H04L 67/26; H04L 67/14; H04L 67/16; H04L 63/126; H04L 67/2809

(57) ABSTRACT

A computer system and method operating with publish-subscribe pattern messaging. A message broker controls internal clients and also manages communication with external clients. To enable communication with the message broker, the external clients use authentication tokens obtained from a trusted authorization server. On receipt of a connect message from an external clients, the message broker extracts and stores relevant information from the token. When connected external clients subsequently publish messages to the message broker, they do so without resending the token, since the message broker has stored the token information itself or in its internal clients. The message broker can then pass on the messages to its internal clients who subscribe to messages of that topic.

### STATEMENT REGARDING PRIOR DISCLOSURES BY THE INVENTOR OR A JOINT INVENTOR

Aspects of the present invention have been disclosed by the Applicant, who obtained the subject matter disclosed directly from the inventor, in the product IBM Watson™ Workplace Essentials, made available to the public on Sep. 26, 2017.

### BACKGROUND

The present disclosure relates to publish-subscribe messaging in which messages are passed between system entities via a message broker. In particular, the present disclosure focuses on how such messaging may be performed with authentication tokens.

A messaging protocol based on a publish-subscribe pattern uses a message broker. Such a messaging protocol provides authentication with username/password through a CONNECT message. Clients publish messages with topics and clients subscribe to receive messages on particular topics. The message broker delivers the published messages it receives to those clients who have subscribed to receive them based on matching topics.

The topics can be freely created by publishing or subscribing clients. Topics are created in a hierarchical manner. For example, for home electrical control, a hierarchy of topics might be based around the house, the room in the house, the electrical appliance in the room, such as: house/room1/main-light; house/room1/alarm; house/garage/main-light; and house/main-door.

A subscriber can then subscribe to topics at any level in the hierarchy, e.g. using a wildcard character “#”. Accordingly, subscribing to “topic house/#” would result in receiving published messages on all the above list, whereas subscribing to “topic house/room1/#” would only result in receiving published messages from the first two items in the list.

In machine-to-machine (M2M) applications and Internet of Things (IoT) applications it is often the case that the communication links between devices have low bandwidth and/or device resources are constrained, e.g. by limitations on energy consumption forced by battery power limitations of IoT devices such as sensors. It would therefore be desirable to support publish-subscribe messaging that allows tokens to be synchronized across a boundary, i.e. between clients, where the devices on one side of the boundary do not have sufficient computing power to negotiate themselves and therefore need to rely on services on the other side of the boundary to do this for them.

### BRIEF SUMMARY OF THE INVENTION

Different aspects of the invention relate to a whole publish-subscribe pattern messaging system, and to individual entities within such a system, namely an external client, an internal client and a message broker. Further the invention also relates to corresponding methods carried out at system level or in the above-named individual entities.

According to an embodiment of the disclosure, there is provided a computer program product for a message broker to support publish-subscribe pattern messaging. The embodiment may include one or more computer-readable tangible storage devices and program instructions stored on at least one of the one or more computer-readable tangible storage devices. The program instructions may include instructions to receive a connect message from an external client. The program instructions may include instructions to establish a connection to the external client in response to receiving the connect message. Establishing the connection to the external client may include program instructions to extract an authentication token from the connect message. Establishing the connection to the external client may also include program instructions to store the authentication token extracted from the connect message for internal clients of the message broker. Establishing the connection to the external client may also include program instructions to receive, from an external client with an established connection, a publish message on a defined topic without an authentication token. Establishing the connection to the external client may also include program instructions to forward the publish message to any one of the internal clients who subscribe to messages of the defined topic.

According to an embodiment of the disclosure, there is provided a computer program product for an internal client operating with publish-subscribe pattern messaging. The internal client is associated with a message broker. The internal client has a local memory for storing authentication tokens, the embodiment may include one or more computer-readable tangible storage devices and program instructions stored on at least one of the one or more computer-readable tangible storage devices. The program instructions may include instructions to establish a connection with the message broker by sending a connect message to the message broker. The program instructions may include instructions to subscribe with the message broker to receive messages relating to any desired topics. The program instructions may include instructions to receive from the message broker authentication tokens relating to external clients with established connections to the message broker. The program instructions may include instructions to receive a message from the message broker without an authentication token. The program instructions may include instructions to store the authentication tokens relating to external clients with established connections to the message broker in the local memory. The program instructions may include instructions to look up an associated authentication token within the authentication tokens relating to external clients with established connections to the message broker stored in the local memory to authenticate the message. The program instructions may include instructions to receive from the message broker messages informing when one or more authentication tokens relating to external clients with established connections to the message broker are no longer valid. The program instructions may include instructions to invalidate the one or more authentication tokens relating to external clients with established connections to the message broker in the local memory.

According to an embodiment of the disclosure, there is provided a computer program product for an external client operating with publish-subscribe pattern messaging. The embodiment may include one or more computer-readable tangible storage devices and program instructions stored on at least one of the one or more computer-readable tangible storage devices. The program instructions may include instructions to request an authentication token from an authorization server. The program instructions may include instructions to receive the authentication token from the authorization server. The program instructions may include instructions to send a connect message containing the authentication token to a message broker. The program instructions may include instructions to receive confirmation from the message broker that a connection has been established. The program instructions may include instructions to send publish messages to the message broker without the authentication token.

According to an embodiment of the disclosure, there is provided a computer system operating with publish-subscribe pattern messaging. The embodiment may include a message broker. The embodiment may include a plurality of internal clients under control of the message broker. The embodiment may include a plurality of external clients not under control of the message broker and in communication with an authorization server from which they can obtain authentication tokens. The embodiment may include one or more processors, one or more computer-readable memories, one or more computer-readable tangible storage devices, and program instructions stored on at least one of the one or more computer-readable tangible storage devices for execution by at least one of the one or more processors via at least one of the one or more memories. The program instructions may include instructions to receive a connect message from an external client of the plurality of external clients. In response to receiving the connect message, the program instructions may include instructions to establish, by the message broker, a connection to the external client. Establishing the connection to the external client may include program instructions to extract, by the message broker, an authentication token from the connect message. Establishing the connection to the external client may include program instructions to store, by the message broker, the authentication token extracted from the connect message for the plurality of internal clients under control of the message broker. Establishing the connection to the external client may include program instructions to receive, by the message broker and from any one of the external clients, of the plurality of external clients, with an established connection, a publish message on a defined topic without an authentication token. Establishing the connection to the external client may include program instructions to forward, by the message broker, the publish message to any one of the internal clients, of the plurality of internal clients, who subscribe to messages of the defined topic.

According to an embodiment of the disclosure, there is provided a method of operating a message broker to support publish-subscribe pattern messaging. The method may include receiving a connect message from an external client. The method may include establishing a connection to the external client, in response to receiving the connect message. Establishing the connection to the external client may include extracting an authentication token from the connect message. Establishing the connection to the external client may include storing the authentication token extracted from the connect message for internal clients of the message broker. Establishing the connection to the external client may include receiving, from an external client with an established connection, a publish message on a defined topic without an authentication token. Establishing the connection to the external client may include forwarding the publish message to any one of the internal clients who subscribe to messages of the defined topic.

In some embodiments, the message broker has a memory for storing authentication tokens and stores the authentication tokens relating to established connections. The authentication tokens are stored in the memory with an association to their respective external clients. The message broker may, in response to receiving a publish message without an authentication token from an external client with an established connection, look up the associated authentication token from the memory and add the authentication token to the publish message before making the publish message available to any ones of the internal clients who subscribe to messages of that topic. The memory may be internal to the message broker or in a third-party entity to which the message broker has access.

In other embodiments, following establishment of a connection to an external client, the message broker may forward the authentication token that has been extracted from the connect message to the internal clients, which store that token in respective local memories. In this case, the tokens may be passed on by the broker to the internal clients by a system publish message using a topic to which internal clients have privileged subscription rights not available to external clients. The message broker may also communicate to its internal clients when an established connection disconnects, so that the internal clients are informed when the authentication token associated with that connection is no longer valid.

In some embodiments, the internal client may pass messages without their associated authentication tokens directly to other internal clients not via the message broker.

In some embodiments, the message broker may have a memory, and the authentication tokens relating to established connections are stored in the memory with an association to their respective external clients. In response to receiving a publish message without an authentication token from an external client with an established connection, the message broker looks up the associated authentication token from the memory and adds the authentication token to the publish message before making the publish message available to any ones of the internal clients who subscribe to messages of that topic.

In other embodiments, following establishment of a connection to one of the external clients, the message broker may pass on the authentication token that has been extracted from the connect message to the internal clients, which store that token in respective local memories.

In some embodiments, the method may further include storing authentication tokens relating to established connections along with associations to their respective external clients. In response to receiving the publish message without an authentication token from an external client with an established connection, the method may further include looking up an associated authentication token from among the stored authentication tokens relating to established connections. The method may further include adding the associated authentication token to the publish message before making the publish message available to any one of the internal clients who subscribe to messages of the defined topic. The authentication tokens can be stored internally in the message broker or in a third-party entity under control of the message broker.

Other embodiments may include, following establishment of a connection to an external client, passing on the authentication token that has been extracted from the connect message to the internal clients, which store that token in respective local memories. The tokens may then subsequently be passed on by the broker to the internal clients by a system publish message using a topic to which internal clients have privileged subscription rights not available to external clients. Further, the message broker should communicate to its internal clients when an established connection disconnects, so that the internal clients are informed when the authentication token associated with that connection is no longer valid.

According to another aspect of the disclosure, there is provided a method of operating an internal client to support publish-subscribe pattern messaging. The internal client being associated with a message broker. The internal client has a local memory for storing authentication tokens. The method may include establishing a connection with the message broker by sending a connect message to the message broker. The method may include subscribing with the message broker to receive messages relating to any desired topics. The method may include receiving from the message broker authentication tokens relating to external clients with established connections with the message broker. The method may include receiving messages from the message broker without authentication tokens. In response to which the method may include looking up the associated authentication token from its local memory to authenticate the message. The method may include receiving from the message broker messages informing when an authentication token is no longer valid, in response to which the internal client invalidates that authentication in the local memory. The method may further include passing messages without their associated authentication tokens directly to other internal clients not via the message broker.

According to another aspect of the disclosure, there is provided a method of operating an external client to support publish-subscribe pattern messaging. The method may include requesting an authentication token from an authorization server. The method may include receiving an authentication token from the authorization server. The method may include sending a connect message containing the authentication token to a message broker. The method may include receiving confirmation from the message broker that a connection has been established. The method may include sending publish messages to the message broker without the authentication token.

According to another aspect of the disclosure, there is provided a method of operating with publish-subscribe pattern messaging in a computer system. The method may include a message broker. The method may include a plurality of internal clients under system control of the message broker. The method may include a plurality of external clients not under system control of the message broker and in communication with an authorization server from which they can obtain authentication tokens. The method may include one of the external clients sending a connect message to the message broker. The method may include establishing a connection between that external client and the message broker. Establishing a connection may include the message broker extracting an authentication token from the connect message. Establishing a connection may include the message broker storing the authentication token for the internal clients of the message broker. The method may include one of the external clients that has an established connection to the message broker sending a publish message on a defined topic to the message broker without an authentication token. The method may include the message broker passing on the message to any ones of the internal clients who subscribe to messages of that topic.

In some embodiments, the message broker has a memory for storing authentication tokens relating to established connections. The authentication tokens are stored in the memory with an association to their respective external clients. In response to receiving a publish message without an authentication token from an external client with an established connection, the message broker looks up the associated authentication token from the memory and adds the authentication token to the publish message before making the publish message available to any ones of the internal clients who subscribe to messages of that topic.

In other embodiments, following establishment of a connection to one of the external clients, the message broker is configured to pass on the authentication token that has been extracted from the connect message to the internal clients, which store that token in respective local memories.

One example permissions credential is a token, for example a JSON web token (JWT).

According to another aspect of the disclosure, there is provided a computer program stored on a computer readable medium and loadable into the internal memory of a computer apparatus, comprising software code portions, when said program is run on a computer apparatus, for performing the above-defined methods. The computer program may be contained in a microservice that is deliverable as a service. A computer program product may also be provided which stores the above-mentioned computer program.

With the proposed approach, applications on each side of a client-client boundary trust a message broker, so that they can then exchange tokens using the messaging protocol based on publish/subscribe patterns. In certain embodiments, network traffic volume between external clients and a message broker can be reduced, since external clients do not need to resend their token with every message, since it is cached by the broker and/or internal services (e.g. internal clients) attached to the broker. Moreover, the tokens can be securely propagated to downstream components with the infrastructure of the broker and its internal services. External clients can thus use tokens, such as JWTs, to connect to the messaging system. The system is scalable system since brokers can scale horizontally and it is not necessary to cluster servers.

In a first specific embodiment, the broker caches the token. All subsequent events received from external clients are now authorized, but also each message has to be modified on its way through the broker by attaching the token to it. With this embodiment, the internal clients do not need to cache the token, but there is the performance overhead that the broker has to modify every message to add the token.

In a second specific embodiment, the broker distributes the token to internal clients using a topic, such as a default topic, and each internal client then caches the token. All subsequent events received from external clients are now authorized (internal clients each then know the token and know it's valid) and the token is propagated securely between internal system calls.

### BRIEF DESCRIPTION OF THE DRAWINGS

In the following, the present invention will further be described by way of example only with reference to exemplary embodiments illustrated in the figures.

FIG. 1 is a schematic system drawing of a first embodiment.

FIG. 2 is a state diagram showing an example message flow in the first embodiment.

FIG. 3 is a schematic system drawing of a second embodiment.

FIG. 4 is a state diagram showing an example message flow in the second embodiment.

FIG. 5 shows a structure of a computer system 20 and computer program 44 that may be used to implement embodiments of the disclosure.

FIG. 6 depicts a cloud computing environment according to an embodiment of the present disclosure.

FIG. 7 depicts abstraction model layers according to an embodiment of the present disclosure.

### DETAILED DESCRIPTION OF THE PREFERRED EMBODIMENTS

In the following detailed description, for purposes of explanation and not limitation, specific details are set forth in order to provide a better understanding of the present disclosure. It will be apparent to one skilled in the art that the present disclosure may be practiced in other embodiments that depart from these specific details.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

In embodiments described below, permissions are contained in and conveyed by JSON web tokens (JWT tokens or JWTs). JSON is an open standard defined in RFC7519, RFC7515, RFC7516 and RFC7797. Of these standards, RFC7519 relates to creating JWTokens. The JWT token is signed by the server's key to enable a client to verify its authenticity. The purpose of a JWT token is to allow secure communication between client and server. JWT tokens are access tokens created by a server for its clients which contain “claims” which are made by the client to the server, “claims” being the term used in RFC7519. The JWT tokens can be stored at the client in client-side storage, e.g. in JavaScript LocalStore. A JWT token is a type of client-accessible credential.

A JWT has three sections: header, payload and signature. The header and payload are Base64-encoded. The signature is created by feeding the header and payload through a signing algorithm (which is specified in the header) together with a private key. The signature can be used to authenticate the JWT token by a verifying entity in possession of the private key.

A simplified form of a JWT token might be as follows:

{... header . . }
{

“iss”: “Some Service”,
“iat”: 1478526974,
“exp”: 1510062974,
“aud”: “test”,
“sub”: “john.smith@example.com”

}
SIGNATURE

Some terminology we use for describing implementations of the disclosure are as follows:

AUTHORIZATION SERVER—a server which controls access to resources by issuing tokens to clients: The authorization server also has the role of revoking previously issued tokens that are in circulation. An Open Authorization (OAuth) server is a particular example of an authorization server. Version 2.0 of Open Authorization (OAuth) is known as OAuth 2.0 or OAuth 2 and is the current version of OAuth. We note the uses of the term ‘OAuth’ in this document should be interpreted generically to mean all versions of OAuth, including OAuth2, and should not be interpreted as being specific to version 1 of OAuth. OAuth is an open standard authorization framework which allows a third party to access a resource without the resource giving unencrypted credentials (e.g. username/password/client id) to the third party. OAuth is commonly used as a way for Internet users to grant websites or applications access to their information on other websites but without giving them the passwords. OAuth provides specific authorization flows for web applications, desktop applications, mobile phones, and home devices. For example, if a mobile app wants to access a user's Google profile to post status updates, the user does not have to give his or her Google password to the app; instead the user logs into Google and as a result the app is authorized to use Google on the user's behalf. The user is able to revoke this authorization any time by deleting the privilege in the Google settings. OAuth is an open standard to enable client access to (web) servers within Hypertext Transfer Protocol (HTTP). OAuth provides a framework by which access tokens can be issued to clients by an authorization server with the approval of the resource owner. A client then uses the access token to access the protected resources hosted by a resource server.

IDENTITY—an actor in the system (e.g. bot, application, developer, admin, internal service):

CLIENT—any software component (e.g. an application) which needs to access a resource on the resource server, e.g. through a system's API. Example clients are: web client, mobile client, user interface (which may be considered a subtype of web client).

CLIENT, EXTERNAL—in a publish-subscribe pattern, an external client is a client not under system control of the message broker and as such not a subscriber to the default topic(s) and hence not a recipient of security context information from the message broker.

CLIENT, INTERNAL—in a publish-subscribe pattern, an internal client is a client under system control of the message broker and as such a subscriber to the default topic(s) and hence recipient of security context information from the message broker.

MESSAGE BROKER—in a publish-subscribe pattern, an intermediary system entity that acts as a conduit for managing the passage of messages between publishers and subscribers based on subscriptions lodged at the message broker.

RESOURCE—any resource in a system (e.g. file, group, chat room).

RESOURCE OWNER—a person, i.e. human, who owns a resource.

RESOURCE SERVER—a server which hosts resources that can only be accessed by authorized users, with access being granted to a requested resource when the client presents a valid access token for that resource.

TOPIC—in a publish-subscribe pattern, a classifying parameter used by publishers and subscribers to indicate message subject matter.

TOPIC, DEFAULT—default topic is a special class of topic which transfers the broker-internal state including security context information, and provides control API functions, to internal clients.

Within these definitions the following service types can be defined.

Authentication service: a component which issues authentication tokens to users, such as clients, dynamically during sessions and which is responsible for establishing user/client-level permissions. The authentication service may request end-user approval, or look for any pre-existing authorizations for users, clients or other criteria.

Functional services: a component responsible for managing specific resources, such as chat rooms, and which provides information about permissions related to those resources.

We now describe two alternative embodiments of the disclosure which each provide integration of publish-subscribe messaging with a token-issuing authentication server which allow tokens to be used within the messaging activity.

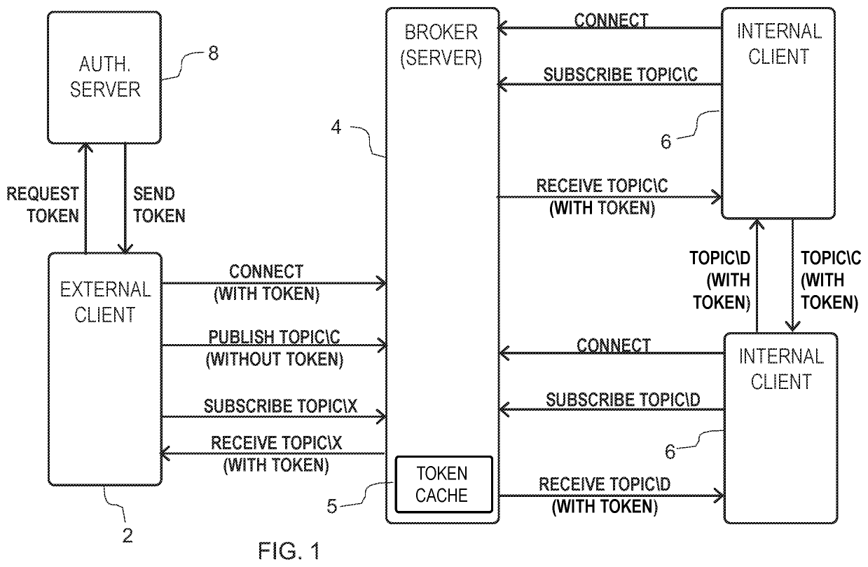

FIG. 1 is a schematic system drawing of a computer system according to a first embodiment. The computer system comprises a message broker 4 and a plurality of internal clients 6 under system control of the message broker. By way of example we show two, but the number is arbitrary and may be anything from one to a large number of hundreds or thousands of internal clients. The computer system further comprises a plurality of external clients 2. By way of example we show only one, but the number is arbitrary and may be anything from one to a large number of hundreds or thousands of external clients. The computer system also includes an authorization server 8 responsible for issuing authentication tokens to system actors, such as the external clients and if desired also the internal clients. The authorization server 8 is shown with message connections to the external client 2, but it will be understood that all system actors may be in message communication with the authorization server.

As schematically illustrated in FIG. 1, the external client 2 initiates authorization flow with the authorization server 8, which issues it a token.

The token is used by the external client 2 in a CONNECT phase to establish a connection with the broker 4, so that the broker 4 can authenticate the external client 2. In the following, we refer to the broker as the server, since it is in a client-server relationship with the clients (i.e. the devices). The broker 4 stores the token in a cache memory 5 of the server 4. The token is then subsequently applied by the server 4 to authenticate every subsequent PUBLISH command received from the external client 2 on the topic authorized by that particular token, so that the external client's authorization to publish on that topic is continually checked. However, the external client does not need to include the token in each of its PUBLISH commands, since the server 4 has stored the token in its memory 5. The memory 5 may be internal to the server 4 or in a third-party entity which the server 4 has access to. The memory 5 may be, for example, a relational or non-relational database such as RDBMS or NoSQL respectively.

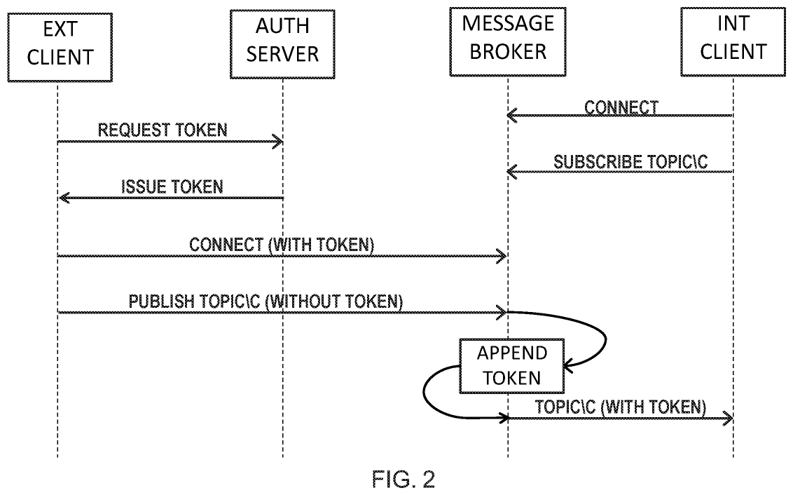

FIG. 2 is a state diagram showing an example message flow in the first embodiment. The external client, referred to in the following as the client, initiates the authentication\authorization flow with the OAuth2 server by requesting and receiving back a JWT that has been cryptographically signed with a public key.

Each client may use an intermediate server (not shown) in order to acquire a server connection URL (websocket, plain TCP etc.) and a list of allowed topics on which to publish and subscribe. In a desired implementation, each client has only one publish and subscribe topic reserved for it. It is useful if the topic format includes a device identifier.

The client sends a CONNECT command to the server including a JWT. The JWT may be placed in: the username field (e.g. 65535 bytes); and/or the password field (e.g. two sub-fields of 65535 bytes).

The token parts can be compressed (e.g. gzip, gz or any other compression type) (payload and/or signatures) to make the token fit into either or both of the above fields. If compression is used, the broker should be configured to understand compressed JWT and decompress it accordingly before parsing. Moreover, other methods can be used here to reduce token size if needed.

The message broker, referred to in the following as the server, is configured to validate the JWT based on the public key, which it may obtain from the OAuth2 server or which may be statically defined.

The server validates the JWT and decodes it to:
extract information about the client's unique device identifier;
build a list of allowed publish and subscribe topics for the client; and
persist the client's security context in memory that is linked to the underlying physical network connection.

The server stores the token and any other topic-specific OAuth token security information in memory optionally backing it up to other persistent storage mechanisms.

The server uses a topic, such as the default topic, to publish information about the successfully connected client along with that client's security context if required. The client subscribes to allowed topics and hence receives messages on that topic from the server that are published by other clients. The client publishes its messages on the authorized topic to the server. The server validates incoming messages published by other clients based on allowed topics and security context information stored in memory or in a third party store. An important check performed by server is to check the JWT has not expired, by checking its expiration time, and that the JWT has not been revoked, by checking the OAuth2 server that issued the JWT. If the token is expired or revoked the server closes the underlying network connection and frees up the associated memory resources. For recently expired or revoked tokens, the server may provide a small leeway time before acting on the token removal. In addition, the server can run other types of validation checks, e.g. based on message payload size or data format.

The Server transmits, on a topic-specific basis, messages it has authorized to those subscribing clients who it has logged as being authorized to receive messages on those topics through prior CONNECT commands. The Server caches the token received in the CONNECT command. All subsequent events received from that external client are now authorized. Each subsequent PUBLISH message from that external client is modified on its way through the Server by the server attaching, i.e. appending the token to the message. That is, since the server has validated the token on subscription, publishing is secured by the token expiration time and the token does not need to be reused or rechecked in every subsequent message publish action.

A principal benefit of the proposed approach is that it avoids the need for clients having to resend the JWT with each published message, thereby reducing the size of the message payload and improving performance in general.

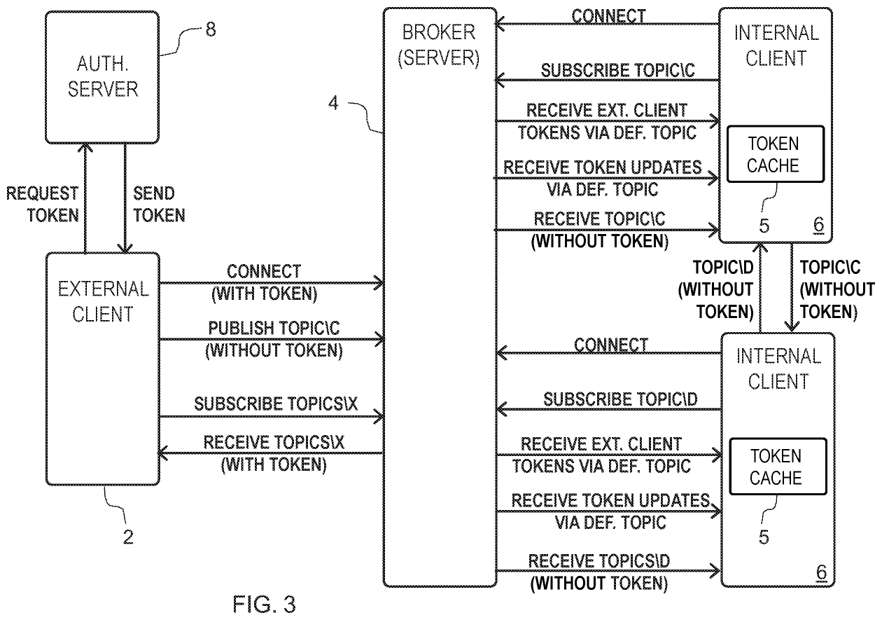

FIG. 3 is a schematic system drawing of a computer system according to a second embodiment. The computer system comprises a message broker 4 and a plurality of internal clients 6 under system control of the message broker. By way of example we show two, but the number is arbitrary and may be anything from one to a large number of hundreds or thousands of internal clients. The computer system further comprises a plurality of external clients 2. By way of example we show only one, but the number is arbitrary and may be anything from one to a large number of hundreds or thousands of external clients. The computer system also includes an authorization server 8 responsible for issuing authentication tokens to system actors, such as the external clients and if desired also the internal clients. The authorization server 8 is shown with message connections to the external client 2, but it will be understood that all system actors may be in message communication with the authorization server.

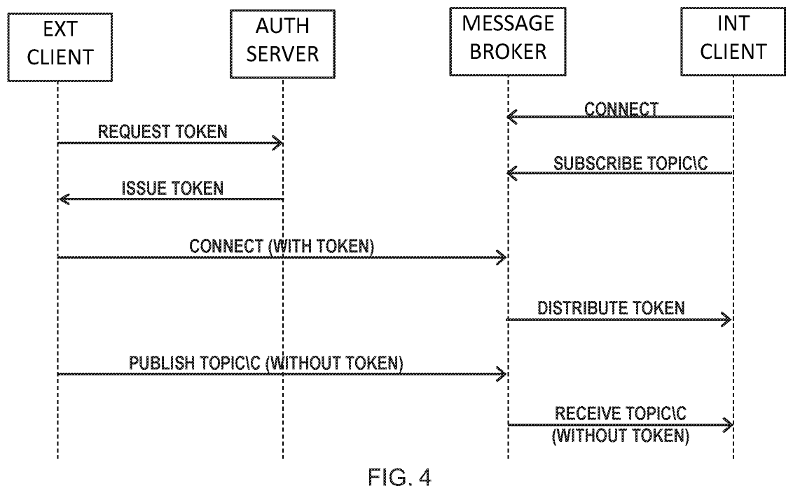

FIG. 4 is a state diagram showing an example message flow in the second embodiment.

The external client, referred to in the following as the client, initiates the authentication\authorization flow with the OAuth2 server by requesting and receiving back a JWT that has been cryptographically signed with a public key. Each client may use an intermediate server (not shown) in order to acquire a server connection URL (websocket, plain TCP etc.) and a list of allowed topics on which to publish and subscribe. In a desired implementation, each client has only one publish and subscribe topic reserved for it. It is useful if the topic format includes a device identifier.

The client sends a CONNECT command to the server including a JWT. The JWT may be placed in: the username field (e.g. 65535 bytes); and/or the password field (e.g. two sub-fields of 65535 bytes).

The token parts can be compressed (e.g. gzip, gz or any other compression type) (payload and/or signatures) to make the token fit into either or both of the above fields. If compression is used, the message broker should be configured to understand compressed JWT and decompress it accordingly before parsing. Moreover, other methods can be used here to reduce token size if needed.

The message broker, referred to in the following as the server, is configured to validate the JWT based on the public key, which it may obtain from the OAuth2 server or which may be statically defined.

The server validates the JWT and decodes it to:
extract information about the client's unique device identifier;
build a list of allowed publish and subscribe topics for the client; and
persist the client's security context in memory that is linked to the underlying physical network connection.

The server does not include the JWT in the messages transmitted to default-topic subscribing clients (i.e. internal clients), but rather relies on the fact that subscribing clients listen to privileged default topics (configured to allow access to a limited number of clients) and the server thus maintains security context per client identifier independently. By default topic we mean a special kind of topic which transfers the broker-internal state and provides control API functions, and hence provide a suitable vehicle for the special measures we propose. That is, we leverage the default topic facility to provide a notification and propagation mechanism for security context (in the form of JWTs) to third party software which can cache it, additionally validate it and have it propagate further to other components if needed.

The default topic, labeled “def. topic” for short in FIG. 3, supports the lifecycle events: CONNECTED and DISCONNECTED which are issued when a particular client connects or disconnects, and also following a connection time-out. The server notifies connected internal systems through the default topic about new client connections with its associated security token which can then be used by the internal systems themselves, and if needed can be propagated between internal systems. The internal clients are therefore kept up to date on connection status of external clients by the server issuing connect/disconnect events to the default topic each time an external client connects/disconnects.

In comparison with the first embodiment, in the second embodiment, the internal clients cache the tokens instead of the server, so the performance overhead of the broker having to append the appropriate token to every message on its way through to the internal clients is removed. Both embodiments however share the benefit that they avoid the need for external clients having to resend the JWT with each PUBLISH message, thereby reducing the size of the message payload and improving performance in general.

Other mechanisms, such as enriching incoming messages with security context can be implemented.

### Example

The above-described embodiments may be implemented in a variety of publish-subscribe protocols, including for example MQTT, which stands for MQ Telemetry Transport. MQTT is a lightweight, open and scalable messaging protocol for machine-to-machine (M2M) communication and the Internet of Things (IoT). MQTT is standardized under ISO/IEC PRF 20922 and also by the Organization for the Advancement of Structured Information Standards (OASIS) as MQTT Version 3.1.1. MQTT enables the transfer of telemetry data between devices in a manner that is robust against network delays, bandwidth limitations and unreliability factors. MQTT is used in many major industries for interconnecting hundreds or thousands of (constrained) devices with minimal effort. It is further noted that MQTT is currently in an advanced state of discussion for updating to Version 5.0 with the latest draft known at the time of writing being the draft of 25 Dec. 2017. The messaging in MQTT is based on a publish-subscribe pattern and requires a message broker. MQTT provides authentication with username/password through its CONNECT message.

MQTT in Version 5.0 draft of 25 Dec. 2017 at Section 5.4.1 entitled “Authentication of Clients by the Server” provides new authentication features compared with Version 3.1.1 as described in Section 4.12 of the draft standard entitled “Enhanced authentication”.

In the MQTT standard, there is a system topic labeled SSYS, which is a pre-defined, default topic that is created for and reserved from message brokers to publish information about the message broker to clients. In MQTT implementations of the invention, the server does not need to include the JWT in the messages transmitted to SSYS subscribing clients (i.e. internal clients), but rather can rely on the fact that subscribing clients listen to privileged SSYS topics (configured to allow access to a limited number of clients) and the server thus maintains security context per client identifier independently. We note that the SSYS prefix is used for special kinds of topics which transfer the broker-internal state and provide control API functions, so SSYS topics provide a suitable vehicle for the special measures we propose. That is, MQTT implementations of the invention may leverage the SSYS topic facility to provide a notification and propagation mechanism for security context (in the form of JWTs) to third party software which can cache it, additionally validate it and have it propagate further to other components if needed. Moreover, in MQTT implementations of the invention, the reserved SYS topic supports the lifecycle events: CONNECTED and DISCONNECTED which are issued when a particular client connects or disconnects, and also following a connection time-out. The server notifies connected internal systems through system (i.e. SSYS) topic about new client connections with its associated security token which can then be used by the internal systems themselves, and if needed can be propagated between internal systems. The internal clients are therefore kept up to date on connection status of external clients by the server issuing connect/disconnect events to SYS topic each time an external client connects/disconnects.

For an MQTT implementation of the above-described embodiments, the client 2 is an MQTT client. An MQTT client may be any device, in particular any IoT device, such as a mobile phone, a browser tab, a browser plugin, a sensor, a gauge, or any other IoT entity. The MQTT client may be an internal or an external client. An internal MQTT client is an MQTT client which is a system-internal service under control of the system administrator. An internal MQTT client is generally trusted by other internal MQTT clients and the MQTT broker. An external MQTT client is an MQTT client which, in order to communicate with the MQTT broker, must first acquire an authentication token (e.g. JWT) from a trusted authorization server (e.g. OAuth server). For instance, any IoT device (mobile phone, thermostat etc.) may be an external MQTT client.

The connect phase is an MQTT connect phase. The broker/server 4 is an MQTT broker/server. It is noted that MQTT has an inbuilt internal mechanism, whereby device session ids and associated security tokens are stored by the MQTT server 4. This internal mechanism can be used in MQTT implementations of the invention to store the token in the memory 5, so that the external client does not need to include the token in each of its PUBLISH commands.

As per MQTT v5 in Section 4.12 entitled “Enhanced authentication” optional authentication schema can be enabled to indicate OAuth authentication schema. This may be implemented as follows: Client to Server CONNECT Authentication Method=“Bearer”. The server Auth flow responses follow the method described in Section 4.12. Since “Authentication Data” will contain a security context token (i.e. a JWT), the JWT can be omitted from the “Password” field. In this paragraph, the use of inverted commas indicates the meanings of these terms are as defined in the standard document, i.e. MQTT v5 draft, or in the case of “Bearer” RFC 6750 of the Internet Engineering Task Force (IETF) entitled: The OAuth 2.0 Authorization Framework: Bearer Token Usage.

A specific example based on MQTT is now described. A user mobile device, acting as an MQTT client, authenticates to an OAuth2 server and receives back a JWT.

The MQTT client sends a request to an intermediate service and receives back an MQTT CONNECT uniform resource identifier (URI) and 2 topic names:

‘user/<user_id>/<device_id>/request’ device-to-server
publish topic
‘user/<user_id>/<device_id>/response’ server-to-device
subscribe topic
wss://mqtt.server.com/mqtt/267913f2d1833294d5a1ca8b19e5bc2
17972ad49bbc45abef8b4b760808aa9a8

The MQTT client initiates MQTT CONNECT to the MQTT server using:

wss://mqtt.server.com/mqtt/267913f2d1833294d5a1ca8b19e5bc2
17972ad49bbc45abef8b4b760808aa9a8

which is the URL that transmits the JWT in its password field.

The MQTT server validates the JWT and builds a list of the above allowed topics for the MQTT client, persists in memory a security context associated with the underlying network connection (token, topics etc.) and publishes MQTT client details and security information into the SSYS topic:

$SYS/brokers/mqttd@127.0.0.1/clients/connected

with the payload:

{“clientid”:“clientIdHQcTcPzcof”,“token”:“eyJhb...”,“ipadd
ress”:“192.168.0.14”,“session”:false,“protocol”:3,“ts”:147
2853978}

All authorized subscribers for the SSYS topic receive the above notification. Authorized subscribers are internal MQTT clients and hence have privileged rights to subscribe to these SSYS topics. An external MQTT client that is not part of the infrastructure under control of a particular MQTT server does not have the right to subscribe to SSYS topics from that MQTT server. The internal MQTT clients are, for example, services which are part of the MQTT server's infrastructure and process external MQTT client requests. These internal MQTT clients have privileged access to subscribe to SSYS topics from their MQTT server and listen to broker notifications from their MQTT server that relate to MQTT client connections, whether those connections are from internal or external MQTT clients.

The MQTT client starts publishing messages to the MQTT server. The MQTT server validates incoming requests with security context (previously stored in memory), token expiration and message payload size. The message is published by the MQTT server to other subscribing, i.e. internal, MQTT clients based on topics and authorizations. When the JWT expires or is revoked, the network connection between the affected MQTT client and the MQTT server is closed.

The MQTT client keeps exchanging messages with the OAuth2 server in order to receive token renewal messages. When the MQTT client receives a new JWT, it reconnects to the MQTT server with a CONNECT command Otherwise, if the MQTT client does not renew its JWT, then the MQTT server will close the physical network connection.

The MQTT implementations of the invention are thus capable of messaging using JWTs as authentication tokens. In MQTT example implementations, network traffic volume between external MQTT clients and MQTT broker can be reduced, since external MQTT clients do not need to resend their token with every message, since it is cached by the MQTT broker and/or internal services (i.e. internal MQTT clients) attached to the MQTT broker. Moreover, the tokens can be securely propagated to downstream components with the infrastructure of the MQTT broker and its internal services. External clients can thus use JWTs to connect to MQTT. The system is scalable system since MQTT brokers can scale horizontally and it is not necessary to cluster MQTT servers.

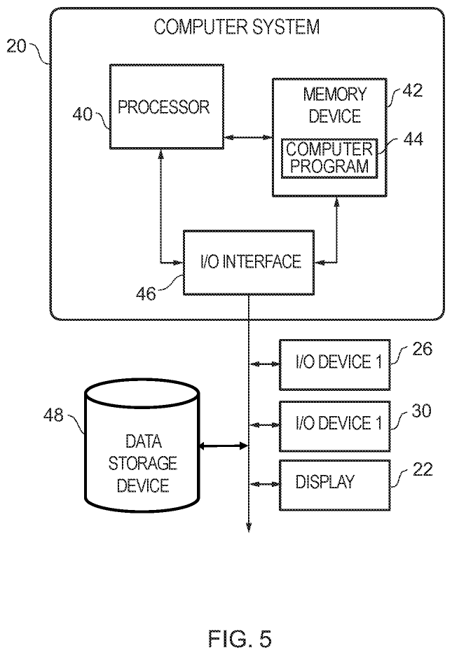

FIG. 5 shows a structure of a computer system 20 and computer program 44 that may be used to implement embodiments of the invention, wherein the computer system may be a network node, such as a client or a server, such as the internal client, external client, authorization server or message broker server referred to above, and the computer program 44 may be an app or a service, such as a microservice, as referred to above. The computer system 20 comprises a processor 40 to provide a processor resource coupled through one or more I/O interfaces 46 to one or more hardware data storage devices 48 and one or more I/O devices 26, 30, which can manage graphic object requests, and a display 22 on which the graphics objects can be displayed. The processor 40 may also be connected to one or more memory devices 42. At least one of the memory devices 42 provides a memory resource which stores computer program 44, which is a computer program that comprises computer-executable instructions. The data storage devices 48 may also store the computer program 44. The computer program 44 stored in the storage devices 48 is configured to be executed by processor 40 via the memory devices 42. The processor 40 executes the stored computer program 44.

It will be clear to one of ordinary skill in the art that all or part of the logical process steps of the preferred embodiment may be alternatively embodied in a logic apparatus, or a plurality of logic apparatus, comprising logic elements arranged to perform the logical process steps of the method and that such logic elements may comprise hardware components, firmware components or a combination thereof.

It will be equally clear to one of skill in the art that all or part of the logic components of the preferred embodiment may be alternatively embodied in logic apparatus comprising logic elements to perform the steps of the method, and that such logic elements may comprise components such as logic gates in, for example, a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In a further alternative embodiment, the present invention may be realized in the form of a computer implemented method of deploying a service comprising steps of deploying computer program operable to, when deployed into a computer infrastructure and executed thereon, cause the computer system to perform all the steps of the method.

It will be appreciated that the method and components of the preferred embodiment may alternatively be embodied fully or partially in a parallel computing system comprising two or more processors for executing parallel software.

A further embodiment of the invention is a computer program product defined in terms of a system and method. The computer program product may include a computer-readable storage medium (or media) having computer-readable program instructions thereon for causing a processor to carry out aspects of the present invention.

The computer-readable storage medium can be a tangible device that can retain and store instructions for use by an instruction execution device

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

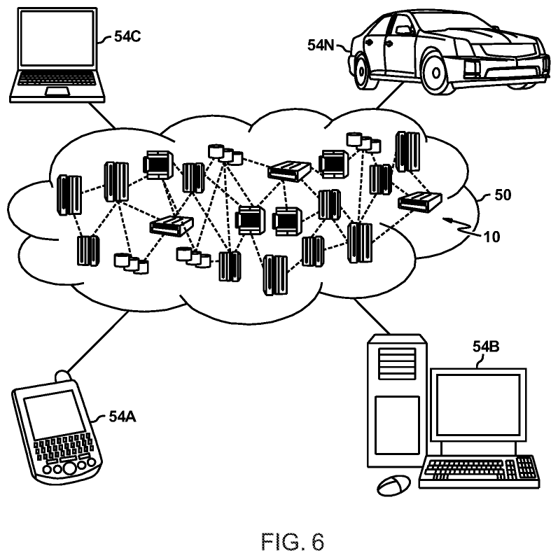

Referring now to FIG. 6, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 10 and cloud computing environment 50 can communicate with any type of computerized device over any type of network and/or network addressable connection (e.g., using a web browser).

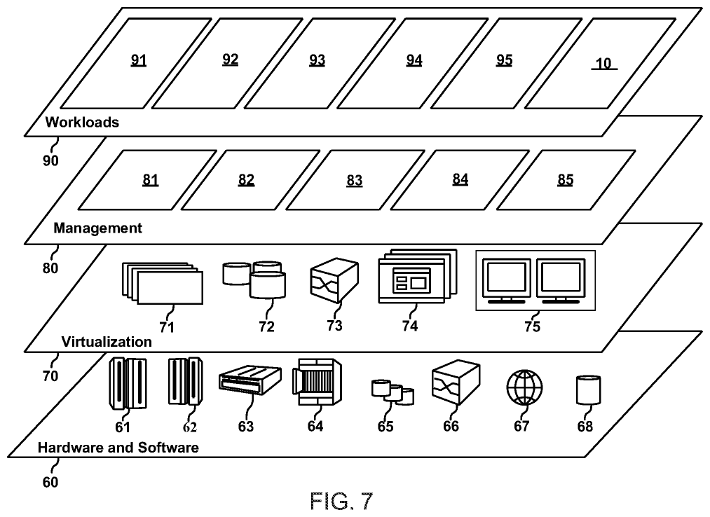

Referring now to FIG. 7, a set of functional abstraction layers provided by cloud computing environment 50 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software lifecycle management 92; virtual classroom education delivery 93; data analytics processing 94; transaction processing 95; and publish-subscribe functions 96 according to embodiments of the invention.

In summary, in the above detailed description we have described how publish-subscribe protocols can be implemented with reduced traffic volumes between external clients (and optionally also in some embodiments internal clients), and a messaging server acting as a broker.

In a typical messaging system of the publish-subscribe type, external clients send large numbers of messages to a messaging server for forwarding to endpoints for processing; those messages contain security credentials with values specific to the client instance; one example of a security credential is an authentication token like a JWT which has a limited life defined by a set expiry time, other security credentials may be constant and retain the same value for the client working session with the messaging server.

In the existing art these security credentials are included in every message sent to the messaging server and carried through to endpoints as the messages are forwarded. What we have described is an approach whereby an external client initially authenticates with the messaging server to establish a connection. The external client sends its security credentials to the messaging server as part of establishing the connection, but does not do so again. Rather, the messaging server caches the security credentials relating to its established connections. The messaging server can store the security credentials itself or in a distributed way by passing them on to each of its internal services, which are referred to as internal clients, which each store them locally.

Subsequent messages are sent from the external client without its security credentials along the previously established connection. The messaging server establishes the source of the message as coming from the same connection.

In the first of our proposed specific solutions, the messaging server appends the cached security credentials to the message before forwarding on to the endpoints, i.e. the internal services; thus optimizing the flow between client and messaging server. The messaging server before appending security credentials for forwarded messages checks that those security credentials are still valid and have not expired or been revoked; where a security credential has expired or been revoked, the messaging server rejects the current message and forces the connection with the client to close, thus the external client receives a disconnect signal from the message broker and is forced to again authenticate with a new connection and send fresh security credentials and finally retransmit the rejected message.

In the second of our proposed specific solutions, the messaging server has previously passed on the security credentials to its internal services for local, distributed storage at each of them. This has the advantage of removing the need for the message broker to append the security credentials to each message as they pass through to the internal clients. This means that the processing step of appending the security credentials to the messages is removed, which should speed up the message flow.

The overall result is a reduction of traffic flow volume between external clients and the messaging server. Moreover, in our second case, there is also a reduction of traffic flow volume between internal clients and the messaging server.

It will be clear to one skilled in the art that many improvements and modifications can be made to the foregoing exemplary embodiment without departing from the scope of the present disclosure.

What is claimed is:

1. A computer program product for a message broker to support publish-subscribe pattern messaging, the computer program product comprising:
one or more computer-readable tangible storage devices and program instructions stored on at least one of the one or more computer-readable tangible storage devices, the program instructions comprising:
program instructions to receive a connect message from an external client; and
program instructions to establish a connection to the external client in response to receiving the connect message, wherein establishing the connection to the external client comprises:
program instructions to extract an authentication token from the connect message;
program instructions to store the authentication token extracted from the connect message for internal clients of the message broker;
program instructions to receive, from an external client with an established connection, a publish message on a defined topic without an authentication token; and
program instructions to forward the publish message to any one of the internal clients who subscribe to messages of the defined topic.

2. The computer program product of claim 1, further comprising a memory, wherein authentication tokens relating to established connections are stored in the memory with an association to their respective external clients, and wherein the programming instructions further comprise instructions to look up an associated authentication token stored in the memory, in response to receiving the publish message, and add the associated authentication token to the publish message before making the publish message available to any one of the internal clients who subscribe to messages of the defined topic.

3. The computer program product of claim 2, wherein the memory is internal to the message broker.

4. The computer program product of claim 2, wherein the memory is in a third-party entity accessible by the message broker.

5. The computer program product of claim 1, further comprising:
program instructions to forward the authentication token extracted from the connect message to the internal clients, following establishment of the connection to the external client, for storage in respective local memories.

6. The computer program product of claim 5, wherein a given authentication token is forwarded by the message broker to the internal clients by a system publish message using a topic to which the internal clients have privileged subscription rights not available to external clients.

7. The computer program product of claim 5, further comprising:
program instructions to communicate to internal clients that the authentication token associated with the established connection is no longer valid based on the established connection disconnecting.

8. A computer program product for an internal client operating with publish-subscribe pattern messaging, wherein the internal client is associated with a message broker, and wherein the internal client has a local memory for storing authentication tokens, the computer program product comprising:
one or more computer-readable tangible storage devices and program instructions stored on at least one of the one or more computer-readable tangible storage devices, the program instructions comprising:
program instructions to establish a connection with the message broker by sending a connect message to the message broker;
program instructions to subscribe with the message broker to receive messages relating to any desired topics;
program instructions to receive from the message broker authentication tokens relating to external clients with established connections to the message broker;
program instructions to receive a message from the message broker without an authentication token;
program instructions to store the authentication tokens relating to external clients with established connections to the message broker in the local memory;
program instructions to look up an associated authentication token within the authentication tokens relating to external clients with established connections to the message broker stored in the local memory to authenticate the message;
program instructions to receive from the message broker messages informing when one or more authentication tokens relating to external clients with established connections to the message broker are no longer valid; and
program instructions to invalidate the one or more authentication tokens relating to external clients with established connections to the message broker in the local memory.

9. The computer program product of claim 8, further comprising:
program instructions to forward messages without associated authentication tokens directly to other internal clients not via the message broker.

10. A method of operating a message broker to support publish-subscribe pattern messaging, the method comprising:
receiving a connect message from an external client; and
establishing a connection to the external client, in response to receiving the connect message, wherein establishing the connection to the external client comprises:
extracting an authentication token from the connect message;
storing the authentication token extracted from the connect message for internal clients of the message broker;
receiving, from an external client with an established connection, a publish message on a defined topic without an authentication token; and
forwarding the publish message to any one of the internal clients who subscribe to messages of the defined topic.

11. The method of claim 10, further comprising:
storing authentication tokens relating to established connections along with associations to their respective external clients;
in response to receiving the publish message, looking up an associated authentication token from among the stored authentication tokens relating to established connections; and
adding the associated authentication token to the publish message before making the publish message available to any one of the internal clients who subscribe to messages of the defined topic.

12. The method of claim 11, wherein the authentication tokens relating to established connections are stored internally in the message broker.

13. The method of claim 11, wherein the authentication tokens relating to established connections are stored in a third-party entity under control of the message broker.

14. The method of claim 10, wherein, further comprising:
following establishment of the connection to the external client, forwarding the authentication token extracted from the connect message to the internal clients for storage in respective local memories.

15. The method of claim 14, wherein a given authentication token is forwarded by the message broker to the internal clients by a system publish message using a topic to which internal clients have privileged subscription rights not available to external clients.

16. The method of claim 14, further comprising:
communicating to internal clients that the authentication token associated with the established connection is no longer valid based on the established connection disconnecting.
